(19) United States
(12) Patent Application Publication
(10) Pub. No.: US 2021/0248615 A1
(43) Pub. Date: Aug. 12, 2021

(54) METHOD AND SYSTEM FOR DIGITALLY ONBOARDING CUSTOMERS FOR PROVIDING ONE OR MORE SOLUTIONS IN REAL-TIME

(71) Applicant: Signzy Technologies Private Limited, Mumbai (IN)

(72) Inventors: Roopam SHUKLA, Mumbai (IN); Sidharth PATTNAIK, Mumbai (IN); Rajdeep SHARMA, Mumbai (IN); Shiv Shankar SUBUDHI, Mumbai (IN); Chitrangada PATRA, Mumbai (IN); Dinesh AVULA, Mumbai (IN); Ankit RATAN, Mumbai (IN); Arpit RATAN, Mumbai (IN); Ankur PANDEY, Mumbai (IN)

(73) Assignee: Signzy Technologies Private Limited, Mumbai (IN)

(21) Appl. No.: 17/126,041

(22) Filed: Dec. 18, 2020

(30) Foreign Application Priority Data
Feb. 12, 2020 (IN) 202021006129

(51) Int. Cl. G06Q 30/00; G06N 5/02; G06N 3/08; G06F 16/435; G06F 16/438; G06F 16/93

(52) U.S. Cl. CPC G06Q 30/01; G06N 5/025; G06F 16/93; G06F 16/435; G06F 16/438; G06N 3/08

(57) ABSTRACT

The present disclosure provides a method and system for onboarding a customer digitally for providing one or more solutions in real-time. The method focuses on receiving a first set of data associated with the customer. In addition, the method focuses on fetching one or more information available in the first set of data associated with the customer. Further, the method focuses on analyzing the first set of data associated with the customer in real-time. Furthermore, the analysis of the first set of data associated with the customer is performed based on one or more parameters. Moreover, the method focuses on authenticating the first set of data associated with the customer. Also, the authentication of the first set of data associated with the customer is performed based on combination of one or more pre-defined set of rules associated with a decision engine. Also, the method focuses on onboarding the customer digitally.

### TECHNICAL FIELD

The present invention relates to the field of customer management and, in particular, relates to a method for onboarding a customer for providing one or more solutions in real-time.

### INTRODUCTION

With advancement of technology in recent years, popularity of online services has gained momentum. These online services platforms provide enormous amount of services to people and makes life of people more robust and hassle-free. These online services have decreased manpower and saves human energy. There are a few online services whose popularity have grown and continue to grow further by day. Those online services include online user onboarding for one or more solutions, online banking, online shopping, online video calling, online text conversation, online voice calling and many more. Among these services, one of the top-notch and most popular services that the internet provides is the user onboarding for banking purposes. Nowadays, consumers from any part of the world can register to for online banking and other related services using their identity proofs issued by the government. Consumers are able to open a new bank account in one go using their smart phones and internet. Consumers can transfer money from one person to another person with help of internet as a medium. However, there are a few issues that consumers still have to face. One of the major issues includes visiting the facility of one or more networking websites manually for verification of the documents. This process of manual verification increases turnaround time and reduces accuracy along with authenticity. Thus, existing systems do not provide validation and authentication at front end. This increases efforts for BSM and DVU units while verifying the documents of the people manually. Also, rate of fraud is quite high as tampered images are submitted by the people to commit a fraud and get an account opened. Moreover, there is no consolidated rule logic built during verification of documents of consumers.

### SUMMARY

In a first example, a computer-implemented method is provided. The computer-implemented method performs onboarding of a customer digitally for providing one or more solutions in real-time. The computer-implemented method includes a first step of receiving a first set of data associated with the customer. In addition, the computer-implemented method includes another step of fetching one or more information available in the first set of data associated with the customer. Further, the computer-implemented method includes yet another step of analyzing the first set of data associated with the customer in real-time. Furthermore, the computer-implemented method includes yet another step of authenticating the first set of data associated with the customer. Moreover, the computer-implemented method includes yet another step of onboarding the customer. Also, the first set of data associated with the customer is received in one or more input formats. Also, the first set of data associated with the customer is received using one or more input hardware devices using a communication device in real-time. Also, the customer onboarding system receives the first set of data associated with the customer for initiating a process of onboarding of the customer digitally in a facility. Also, the customer onboarding system fetches the one or more information available in the first set of data associated with the customer in real-time. Also, the customer onboarding system analyzes the first set of data associated with the customer based on one or more parameters. Also, the customer onboarding system analyzes and auto fills the first set of data associated with the customer using one or more algorithms. Also, the customer onboarding system authenticates the first set of data associated with the customer based on combination of one or more pre-defined set of rules associated with a decision engine. Also, the decision engine makes a decision based on combination of the one or more pre-defined set of rules associated with the decision engine. The different combination of the pre-defined set of rules is determined on real-time dynamic basis for different customers. Also, the customer onboarding system onboards the customer digitally for providing the one or more solutions associated with the facility. Also, the customer onboarding system onboards the customer based on the decision made by the decision engine in real-time.

In an embodiment of the present disclosure, the first set of data associated with the customer includes one or more government identity proofs of the customer, one or more address verification proofs of the customer and valid GST certificate of a business that the customer owns. In addition, the one or more government identity proof of the customer includes passport of the customer, birth certificate of the customer, driving license of the customer, social security card of the customer, society welfare card of the customer, income tax card of the customer, ration card of the customer, domicile card of the customer and voter ID card of the customer. In addition, the one or more address verification proof of the customer includes electricity bill of the customer, water consumption bill of the customer, gas consumption bill of the customer, rent agreement of the customer and telephone bill of the customer.

In an embodiment of the present disclosure, the one or more input formats include one or more multimedia formats of the first set of data associated with the customer. In addition, the one or more multimedia formats of the first set of data associated with the customer includes image, video, audio, text and animation.

In an embodiment of the present disclosure, the one or more input hardware devices include one or more optical devices, microphone, and one or more sensors. In addition, the one or more optical devices includes smartphone camera, film camera, bridge camera, night vision camera, thermal imaging camera, infrared camera and mirror less camera. In addition, the one or more sensors includes accelerometer, gyroscope, barometer, and proximity sensor. In addition, the one or more input hardware devices are associated with the communication device.

In an embodiment of the present disclosure, the one or more information available in the first set of data associated with the customer includes name of the customer, date of birth of the customer, address of the customer, gender of the customer, guardian's name of the customer and a unique identity number of the customer.

In an embodiment of the present disclosure, the one or more parameters include one or more metadata checks, one or more image quality checks, face extraction check, identity type check, one or more identity validity checks, and text readability check. In addition, one or more metadata checks include modification date check, photo shop check and data modification check. In addition, the one or more image quality checks include sharpness check, brightness check and text quality check. In addition, the one or more identity validity checks include digital photo shop check, digital tampering check and Xerox copy check.

In an embodiment of the present disclosure, the analyzing is done based on the one or more algorithms. In addition, the one or more algorithms include one or more machine learning algorithm. In addition, the one or more machine learning algorithms includes one or more subsets. In addition, the one or more subsets includes one or more deep learning models and one or more neural network models.

In an embodiment of the present disclosure, the method includes yet another step of authorizing modification of the one or more pre-defined set of rules. In addition, the customer onboarding system authorizes the facility for modifying the one or more pre-defined set of rules based on alteration of policies fabricated by the administrator. In addition, the modification of the one or more pre-defined set of rules is performed in real-time.

In an embodiment of the present disclosure, the method includes yet another step of detecting pseudo documents uploaded by the customer. In addition, the customer onboarding system detects the pseudo documents uploaded by the customer in real-time. In addition, the customer onboarding system does not onboard the customer based on the pseudo documents uploaded by the customer.

In an embodiment of the present disclosure, the method includes yet another step of providing access to a valid customer. In addition, the customer onboarding system provides access to the valid customer for operating the customer onboarding system based on one or more authentication factors. In addition, the one or more authentication factors include biometric authentication, face recognition, voice recognition, lip synchronization, text authentication.

In a second example, a computer system is provided. The computer system includes one or more processors, and a memory. The memory is coupled to the one or more processors. The memory stores instructions. The instructions are executed by the one or more processors. The execution of the instructions causes the one or more processors to perform a method for onboarding a customer digitally for providing one or more solutions in real-time. The method includes a first step of receiving a first set of data associated with the customer. In addition, the method includes another step of fetching one or more information available in the first set of data associated with the customer. Further, the method includes yet another step of analyzing the first set of data associated with the customer in real-time. Furthermore, the method includes yet another step of authenticating the first set of data associated with the customer. Moreover, the method includes yet another step of onboarding the customer. Also, the first set of data associated with the customer is received in one or more input formats. Also, the first set of data associated with the customer is received using one or more input hardware devices using a communication device in real-time. Also, the customer onboarding system receives the first set of data associated with the customer for initiating a process of onboarding of the customer digitally in a facility. Also, the customer onboarding system fetches the one or more information available in the first set of data associated with the customer in real-time. Also, the customer onboarding system analyzes the first set of data associated with the customer based on one or more parameters. Also, the customer onboarding system analyzes and auto fills the first set of data associated with the customer using one or more algorithms. Also, the customer onboarding system authenticates the first set of data associated with the customer based on combination of one or more pre-defined set of rules associated with a decision engine. Also, the decision engine makes a decision based on combination of the one or more pre-defined set of rules associated with the decision engine. The different combination of the pre-defined set of rules is determined on real-time dynamic basis for different customers. Also, the customer onboarding system onboard the customer digitally for providing the one or more solutions associated with the facility. Also, the customer onboarding system onboard the customer based on the decision made by the decision engine in real-time.

In an embodiment of the present disclosure, the first set of data associated with the customer includes one or more government identity proofs of the customer, one or more address verification proofs of the customer and valid GST certificate of a business that the customer owns. In addition, the one or more government identity proof of the customer includes passport of the customer, birth certificate of the customer, driving license of the customer, social security card of the customer, society welfare card of the customer, income tax card of the customer, ration card of the customer, domicile card of the customer and voter ID card of the customer. In addition, the one or more address verification proof of the customer includes electricity bill of the customer, water consumption bill of the customer, gas consumption bill of the customer, rent agreement of the customer and telephone bill of the customer.

In an embodiment of the present disclosure, the one or more input formats include one or more multimedia formats of the first set of data associated with the customer. In addition, the one or more multimedia formats of the first set of data associated with the customer includes image, video, audio, text and animation.

In an embodiment of the present disclosure, the one or more information available in the first set of data associated with the customer includes name of the customer, date of birth of the customer, address of the customer, gender of the customer, guardian's name of the customer and a unique identity number of the customer.

In an embodiment of the present disclosure, the one or more parameters include one or more metadata checks, one or more image quality checks, face extraction check, identity type check, one or more identity validity checks, and text readability check. In addition, one or more metadata checks include modification date check, photo shop check and data modification check. In addition, the one or more image quality checks include sharpness check, brightness check and text quality check. In addition, the one or more identity validity checks include digital photo shop check, digital tampering check and Xerox copy check.

In an embodiment of the present disclosure, the analyzing is done based on the one or more algorithms. In addition, the one or more algorithms include one or more machine learning algorithm. In addition, the one or more machine learning algorithms includes one or more subsets. In addition, the one or more subsets includes one or more deep learning models and one or more neural network models.

In an embodiment of the present disclosure, the method includes yet another step of authorizing modification of the one or more pre-defined set of rules. In addition, the customer onboarding system authorizes the facility for modifying the one or more pre-defined set of rules based on alteration of policies fabricated by the administrator. In addition, the modification of the one or more pre-defined set of rules is performed in real-time.

In an embodiment of the present disclosure, the method includes yet another step of detecting pseudo documents uploaded by the customer. In addition, the customer onboarding system detects the pseudo documents uploaded by the customer in real-time. In addition, the customer onboarding system does not onboard the customer based on the pseudo documents uploaded by the customer.

In an embodiment of the present disclosure, the method includes yet another step of providing access to a valid customer. In addition, the customer onboarding system provides access to the valid customer for operating the customer onboarding system based on one or more authentication factors. In addition, the one or more authentication factors include biometric authentication, face recognition, voice recognition, lip synchronization, text authentication.

In a third example, a non-transitory computer-readable storage medium is provided. The non-transitory computer-readable storage medium encodes computer executable instructions that, when executed by at least one processor, performs a method for onboarding a customer digitally for providing one or more solutions in real-time. The method includes a first step of receiving a first set of data associated with the customer. In addition, the method includes another step of fetching one or more information available in the first set of data associated with the customer. Further, the method includes yet another step of analyzing the first set of data associated with the customer in real-time. Furthermore, the method includes yet another step of authenticating the first set of data associated with the customer. Moreover, the method includes yet another step of onboarding the customer. Also, the first set of data associated with the customer is received in one or more input formats. Also, the first set of data associated with the customer is received using one or more input hardware devices using a communication device in real-time. Also, the customer onboarding system receives the first set of data associated with the customer for initiating a process of onboarding of the customer digitally in a facility. Also, the customer onboarding system fetches the one or more information available in the first set of data associated with the customer in real-time. Also, the customer onboarding system analyzes the first set of data associated with the customer based on one or more parameters. Also, the customer onboarding system analyzes and auto fills the first set of data associated with the customer using one or more algorithms. Also, the customer onboarding system authenticates the first set of data associated with the customer based on combination of one or more pre-defined set of rules associated with a decision engine. Also, the decision engine makes a decision based on combination of the one or more pre-defined set of rules associated with the decision engine. The different combination of the pre-defined set of rules is determined on real-time dynamic basis for different customers. Also, the customer onboarding system onboard the customer digitally for providing the one or more solutions associated with the facility. Also, the customer onboarding system onboard the customer based on the decision made by the decision engine in real-time.

### BRIEF DESCRIPTION OF THE DRAWINGS

Having thus described the invention in general terms, reference will now be made to the accompanying drawings, which are not necessarily drawn to scale, and wherein:

FIG. 1 illustrates a general overview of an interactive computing environment for onboarding a customer digitally for providing them one or more solutions in real-time, in accordance with various embodiments of the present disclosure;

FIG. 2 illustrates a flow chart of a method for onboarding a customer digitally for providing them one or more solutions in real-time, in accordance with various embodiments of the present disclosure; and

FIG. 3 illustrates a block diagram of a computing device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

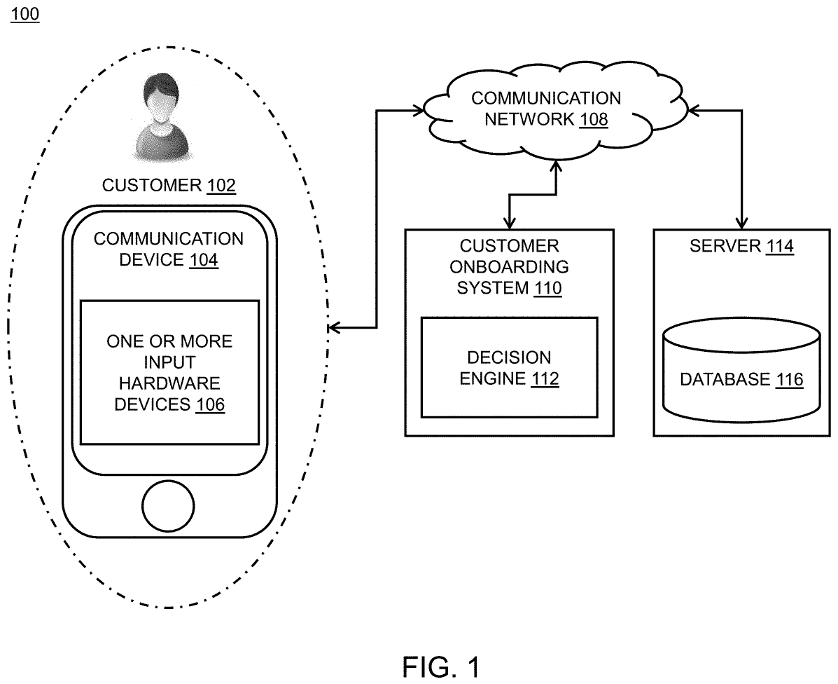

FIG. 1 illustrates an interactive computing environment 100 for onboarding a customer 102 digitally for providing one or more solutions in real-time, in accordance with various embodiments of the present disclosure. The interactive computing environment 100 includes the customer 102, a communication device 104, one or more input hardware devices 106, a communication network 108, a customer onboarding system 110, a decision engine 112, a server 114 and a database 116.

The interactive computing environment 100 includes the customer 102. In an embodiment of the present disclosure, the customer 102 is any legal or natural person. In addition, the customer 102 may be an owner of a business or an employee in an organization or a student in a university. In another embodiment of the present disclosure, the customer 102 wants to use one or more features associated with the facility. In addition, the facility includes but may not limited to a financial institution, a bank, a non-financial institution, an organization, a supermarket, a departmental store, one or more nexus, a university and the like. In addition, the one or more nexus includes sports nexus, activity nexus, shopping nexus and the like. In yet another embodiment of the present disclosure, the customer 102 wants to open a current account for the business that the customer 102 owns in the facility. In yet another embodiment of the present disclosure, the customer 102 wants to open a savings account for personal use in the facility. In yet another embodiment of the present disclosure, the customer 102 wants to get registered with the facility. In yet another embodiment of the present disclosure, the customer 102 needs loan for personal cause from the facility.

In addition, the customer 102 is a person that has ability to operate the communication device 104. In an embodiment of the present disclosure, the customer 102 has the ability to troubleshoot and maintain the communication device 104. The customer 102 has capability to perform one or more functions using the communication device 104. In yet another embodiment of the present disclosure, the communication device 104 is installed with the customer onboarding system 110. In yet another embodiment of the present disclosure, the customer onboarding system 110 is associated with the facility. The customer 102 is the owner of the communication device 104. In addition, the communication device 104 belongs to the customer 102. In yet another embodiment of the present disclosure, the customer 102 utilizes the customer onboarding system 110 for the one or more solutions in real-time. In addition the one or more solutions include but may not be limited to opening of an account either current or savings, requirement of loan, registering on a portal of the organization and the like. In addition, the customer 102 may be located at any place. The customer 102 may be located in any indoor location (home, office, factory, cinema hall or any other type of indoor place) or the customer 102 may be located in any outdoor place (a mall, an amusement park, an airport or any other type of outdoor place).

The interactive computing environment 100 includes the communication device 104. The communication device 104 is associated with the customer 102. In an embodiment of the present disclosure, the customer 102 performs the one or more functions using the communication device 104. In another embodiment of the present disclosure, the communication device 104 is a portable device. The communication device 104 include but may not be limited to a smartphone, a laptop, a personal desktop, a tablet and a personal assistant. In an example, the smartphone may be an Apple smartphone, Android smartphone, a Windows smartphone and the like. In yet another embodiment of the present disclosure, the communication device 104 is fixed communication devices. In an example, the fixed communication devices include a desktop, a workstation PC and the like. The communication device 104 runs on an operating system. In general, the operating system provides an interface for customer to interact with hardware of each of the communication devices and other connected devices. In an example, the operating system installed in the communication device 104 is a Windows based operating system. In another example, the operating system installed in the communication device 104 is a Mac based operating system. In yet another embodiment of the present disclosure, the operating system installed in the communication device 104 is a Linux based operating system. In yet another example, the operating system installed in the communication device 104 is a mobile operating system. In an example, the mobile operating system includes but may not be limited to Android operating system, Apple iOS, Symbian based operating system, BADA operating system and blackberry operating system. In addition, the communication device 104 is working accurately in real-time. In yet another embodiment of the present disclosure, the communication device 104 is internet enabled devices. Further, the communication device 104 is connected to the communication network 108.

The interactive computing environment 100 includes the one or more input hardware devices 106. In an embodiment of the present disclosure, the communication device 104 includes the one or more input hardware devices 106. The one or more input hardware devices 106 are associated with the communication device 104. In general, input device is a piece of computer hardware equipment used to provide data and control signals to an information processing system. In example, the information processing system includes computer system, information appliances and the like. The one or more input hardware devices 106 include but may not be limited to a microphone, a camera, a keyboard, a mouse, a joystick, a light pen, integrated circuits, a scanner and the like. The one or more input hardware devices 106 are used to receive input in one or more formats. In another embodiment of the present disclosure, the one or more input hardware devices 106 are used to receive a first set of data from the customer 102.

In general, the microphone is used to receive input in form of audio. In addition, the camera is used to take input in form of visual and video. In addition, the keyboard is used to receive input in form of text. In addition, the light pen is used to receive input in multiple formats. In addition, the scanner is used to give input to a system by scanning the documents. The one or more input hardware devices 106 receive the first set of data associated with the customer 102 in the one or more input formats. The one or more input formats include but may not limited to video data, audio data, biometric authentication, text data and the like. The communication system 104 utilizes the one or more input hardware devices 106 to provide input to the customer onboarding system 110 using the communication network 108.

The interactive computing environment 100 includes the communication network 108. The communication network 108 acts as a medium for the communication device 104 to connect to the customer onboarding system 110. The communication network 108 provides network connectivity to the communication device 104 using one or more methods. The one or more methods include 2G, 3G, 4G, 5G, Wi-Fi, and the like. In an example, the communication network 108 includes but may not be limited to a local area network, a metropolitan area network, a wide area network, a virtual private network, a global area network and a home area network. In an embodiment of the present disclosure, the communication device 104 access data over the communication network 108 by utilizing one or more applications.

In addition, the one or more applications include but may not be limited to a web browser, a mobile application, a widget and web applets. In general, each of the one or more applications have a graphical user interface (hereinafter “GUI”) that is designed to display and fetch data from a designated server. In addition, each of the one or more applications on any of the one or more communication devices associated with the customer may provide an interface for real-time streaming, uploading and downloading of video files and audio files. The web browser installed in the communication device 104 may be any web browser. In an example, the web browsers include Google Chrome, Mozilla Firefox, Opera, UC Web, Safari, Internet Explorer and the like. In addition, the mobile application installed in at least one of the one or more communication devices may be based on any mobile platform. Examples of the mobile platform include but may not be limited to Android, iOS Mobile, Blackberry and Bada operating system.

The interactive computing environment 100 includes the customer onboarding system 110. In an embodiment of the present disclosure, the customer 102 utilizes the communication device 104 to access the customer onboarding system 110. In addition, the customer onboarding system 110 is a system that provides the one or more solutions to the customer 102 in real-time. In addition, the customer onboarding system 110 onboard the customer 102 for the one or more solutions in real-time. In yet another embodiment of the present disclosure, the customer onboarding system 110 onboard the customer 102 in robust, secure and hassle-free manner. In addition, the customer onboarding system 110 also decreases the onboarding turnaround time. In general, the turnaround time is total time taken between the submission of a process for execution and the return of the complete output to the customer/user. In addition, the customer onboarding system 110 has increased security level for authentication, validation and verification. In addition, the customer onboarding system 110 onboard the customer 102 digitally with higher accuracy and higher rate of authenticity.

The interactive computing environment 100 includes the decision engine 112. In an embodiment of the present disclosure, the decision engine 112 is associated with the customer onboarding system 110. In another embodiment of the present disclosure, the decision engine 112 makes a decision based on combination of one or more pre-defined set of rules associated with the decision engine 112. The different combination of the pre-defined set of rules is determined on real-time dynamic basis for different customers. In addition, the decision engine 112 performs one or more tasks based on one or more machine learning algorithms. In general, machine learning is an application of artificial intelligence that provides system the ability to learn and improve automatically from experience without being explicitly programmed. In addition, machine learning focuses on the development of computer programs that can access data and learn from data by itself. Further, machine learning is categorized into three categories. The three categories of machine learning includes supervised learning, unsupervised learning, and reinforcement learning. The one or more machine learning algorithms include logistic regression, random forest, decision tree, support vector machine and KNN, naïve-bayes and the like. In addition, the one or more machine learning algorithms include one or more subsets. In addition, the one or more subsets include one or more deep learning models and one or more neural network models.

In addition, the one or more tasks include cross linkage between the first set of data associated with the customer 102, qualitative and quantitative interferences drawn from the first set of data associated with the customer 102, mimicking human verification, modification of the one or more pre-defined set of rules in the decision engine 112 in real-time and the like.

In addition, the decision engine 112 is configured with one or more rule-based checks. The one or more rule-based checks include artificial intelligence-based decision engine, custom and bank specific rules, backend modular rule creator, easy integration and the like. In addition, the one or more rule-based checks have one or more salient features. In addition, the one or more salient features associated with the artificial intelligence-based decision engine include real-time decisions accounting for the real-world practical problems, reduction in turnaround time to onboard the customer 102 using STP mode and the like.

In addition, the one or more salient features associated with the custom and bank specific rules include one or more facility level rules, one or more entity level rules, one or more facility specific checks and the like. Further, the one or more facility level rules include cross verification of one or more identity proofs associated with the customer 102, image forgery-based rules, fetching of data from trusted and genuine data source only, mitigating identity frauds and the like. In addition, the one or more entity level rules include the cross verification of one or more identity proofs, pin-code verification of the customer 102 and the like. In addition, one or more the facility specific checks include inspection of negative pin-codes, inspection of the bank account shared is active or not and the like.

In addition, the one or more salient features associated with the backend modular rule creator include custom rule creator, modifiable verification engine creator and the like. In an embodiment of the present disclosure, the custom rule creator allows the administrator to create, modify and delete new rules in real-time. In addition, the one or more salient features associated with the easy integration include comprehensive plug-n-play functionality.

The interactive computing environment 100 includes the server 114. In an embodiment of the present disclosure, the customer onboarding system 110 has the server 114. In another embodiment of the present disclosure, the server 114 is part of the customer onboarding system 110. The server 114 handles each operation and task performed by the customer onboarding system 110. The server 114 stores one or more instructions and one or more processes to perform various operations of the customer onboarding system 110. In an embodiment of the present disclosure, the server 114 is a cloud server. The cloud server is built, hosted and delivered through a cloud computing platform. In general, cloud computing is a process of using remote network server that are hosted on the internet to store, manage, and process data. Further, the server 114 has the database 116.

The interactive computing environment 100 includes the database 116. The database 116 is used for storage purposes. The database 116 is associated with the server 114. In general, database is a collection of information that is organized so that it can be easily accessed, managed and updated. In an embodiment of the present disclosure, the database 116 provides storage location to all data and information required by the customer onboarding system 110. In an embodiment of the present disclosure, the database 116 may be one of at least hierarchical database, network database, relational database, object-oriented database and the like. However, the database 116 is not limited to the above-mentioned databases.

The customer onboarding system 110 is associated with the communication device 104. The communication device 104 is associated with the customer 102. In an embodiment of the present disclosure, the customer onboarding system 110 receives the first set of data associated with the customer 102. The first set of data associated with the customer 102 includes one or more government identity proofs of the customer 102, one or more address verification proofs of the customer 102 and valid GST certificate of the business that the customer 102 owns. In addition, one or more the government identity proof of the customer 102 includes passport of the customer 102, birth certificate of the customer 102, driving license of the customer 102, social security card of the customer 102, society welfare card of the customer 102, income tax card of the customer 102, ration card of the 102, domicile card of the customer 102, voter ID card of the customer 102 and the like. In addition, the one or more address verification proofs of the customer 102 includes electricity bill of the customer 102, water consumption bill of the customer 102, gas consumption bill of the customer 102, rent agreement of the customer 102 and telephone bill of the customer 102.

In addition, the customer onboarding system 110 receives the first set of data associated with the customer 102 in the one or more input formats. The one or more input formats include one or more multimedia formats. In addition, the one or more multimedia formats include but may not be limited to image, audio, video, text and the like. Further, the customer onboarding system 110 receives the first set of data associated with the customer 102 using the one or more input hardware devices 106. The one or more input hardware devices 106 include one or more optical devices, a microphone, one or more sensors and the like. In an example, the one or more optical devices 106 include but not limited to a smartphone camera, a film camera, a bridge camera, a night vision camera, a thermal imaging camera, an infrared camera and a mirror less camera. In another example, the one or more sensors include but not limited to accelerometer sensor, gyroscope sensor, barometer sensor and proximity sensor. In another embodiment of the present disclosure, the one or more input hardware devices 106 are associated with the communication device 104. In addition, the customer onboarding system 110 receives the first set of data associated with the customer 102 to initiate a process that onboard the customer 102 for the one or more solutions in the facility.

In addition, the customer onboarding system 110 fetches one or more information available in the first set of data associated with the customer 102. In an embodiment of the present disclosure, the one or more information available in the first set of data associated with the customer 102 is fetched automatically in real-time. In addition, the one or more information available on the first set of data associated with the customer 102 include but may not be limited to name of the customer 102, date of birth of the customer 102, address of the 102, gender of the customer 102, guardian's name of the customer 102, a unique identity number of the customer 102 and the like. In addition, one or more key benefits associated with automatic fetching of the one or more information include increment in sales force, replacement of BSM and DVU unit, decrement in turnaround time, reduction in amount of customer efforts and the like.

Further, the customer onboarding system 110 analyzes the first set of data associated with the customer 102. In addition, the customer onboarding system 110 analyzes the first set of data associated with the customer 102 in real-time. Moreover, the customer onboarding system 110 analyzes the first set of data associated with the customer 102 based on one or more parameters. In addition, the customer onboarding system 110 analyzes the first set of data associated with the customer 110 using the one or more machine learning algorithms. In an example, the one or more machine learning algorithms include logistic regression, random forest, decision tree, support vector machine and KNN, naïve-bayes and the like.

In addition, the one or more parameters include one or more metadata checks, one or more image quality checks, face extraction check, identity type check, one or more identity validity checks, text readability check and the like. In addition, the one or more meta data checks include modification date check, photo shop check and data modification check and the like. Further, the one or more image quality checks include sharpness check, brightness check and text quality check. In addition, the one or more identity validity checks include digital photo shop check, digital tampering check and Xerox copy check.

Further, the customer onboarding system 110 performs authentication of the first set of data associated with the customer 102. In addition, the customer onboarding system 110 authenticates the first set of data associated with the customer 102 based on combination of the one or more pre-defined set of rules associated with the decision engine 112. In an embodiment of the present disclosure, the decision engine 112 is associated with the customer onboarding system 110. In another embodiment of the present disclosure, the decision engine 112 makes a decision to authenticate the first set of data associated with the customer 102. In addition, the decision engine 112 makes the decision based on the combination of the one or more pre-defined set of rules associated with the decision engine 112. In addition, the one or more pre-defined set of rules is defined by an administrator. In addition, the administrator includes central government of a country, state government of a state and management committee of the facility.

Furthermore, the customer onboarding system 110 performs onboarding of the customer 102 digitally for the one or more solutions associated with the facility in real-time. In addition, the customer onboarding system 110 onboard the customer 102 based on the decision made by the decision engine 112. In general, onboarding is the action of integrating a new customer in the facility to access products and services of the facility. In addition, the customer onboarding system 110 compares the first set of data associated with the customer 102 to a threshold value. In addition, the customer onboarding system 110 takes the decision to onboard the customer 102 based on the combination of the one or more pre-defined set of rules associated with the decision engine 112.

In addition, the customer onboarding system 110 onboard the customer 102 only when value of the first set of data associated with the customer 102 is greater than the threshold value that is set by the administrator. In an embodiment of the present disclosure, the customer onboarding system 110 enables a valid customer to access the customer onboarding system 110. In addition, the customer onboarding system 110 grants access of the customer onboarding system 110 to the valid customer strictly. In addition, the customer onboarding system 110 onboard the customer 102 by replacing need of manual process of form filling with automatic form filling process. In an embodiment of the present disclosure, the customer onboarding system 110 automatically fills form of the customer 102.

In addition, the one or more key benefits of automatic form filling process include higher accuracy, greater authenticity, faster response time, reduces turnaround time, covers wider geographies, and the like. In addition, the customer onboarding system 110 onboard the customer 102 based on address proof of the customer 102, driving license of the customer 102, voter ID card of the customer 102, GST certificate of business that the customer 102 owns and the like. In addition, the customer onboarding system 110 onboard the customer 102 based on one or more original documents specifically. In an embodiment of the present disclosure, the customer onboarding system 110 is powered by the one or more artificial intelligence based models that detect the one or more documents of the customer 102. In addition, the customer onboarding system 110 detects either the one or more documents of the customer 102 are original or not.

In an example, a user X wants to open a current account in a financial institution. The user X utilizes the communication device 104 to initiate onboarding process. The communication device 104 is installed with the customer onboarding system 110. The user X utilizes the customer onboarding system 110 with the help of the communication device 104 and the communication network 108. Further, the customer onboarding system 110 receives information of the user X. Further, the customer onboarding system 110 analyzes the information to produce an analyzed result using one or more machine learning algorithms and one or more artificial intelligence model. Further, the customer onboarding system 110 validates the analyzed result based on the one or more predefined set of rules. Further, the customer onboarding system 110 uses fuzzy logics and compare the analyzed result with the threshold set of values to produce an output result. The output result includes a status of the application that the application is either safe or risky, or uncertain. Further, the customer onboarding system 110 onboard the user X based on the status of the application of the user X.

In an embodiment of the present disclosure, the customer onboarding system 110 authorizes the facility to modify the one or more pre-defined set of rules associated with the decision engine 112. In addition, the customer onboarding system 110 authorizes the facility to modify the one or more pre-defined set of rules in real-time. In addition, the modification of the one or more pre-defined set of rules is based on alteration of policies fabricated by the administrator. In an example, administrator has introduced one or more new formalities to be completed while onboarding for one or more solutions related to the facility. In addition, the facility is able to make changes in the customer onboarding system 110 as per the one or more new formalities introduced by the administrator.

In an embodiment of the present disclosure, the customer onboarding system 110 detects pseudo documents uploaded by the customer 102. In addition, the customer onboarding system 110 detects the pseudo documents uploaded by the customer 102 in real-time using artificial intelligence. In another embodiment of the present disclosure, the customer onboarding system 110 doesn't onboard the customer 102 based on the pseudo documents uploaded by the customer 102. In an example, a user Y wants to open a current account in a financial institution. The user Y utilizes the communication device 104. The communication device 104 is installed with the customer onboarding system 110. The user Y utilizes the customer onboarding system 110 with help of the communication device 104 and the communication network 108. The customer onboarding system 110 utilizes the one or more input hardware devices 106 to receive documents of the user Y. The user Y provides pseudo or fake voter ID card. The customer onboarding system 110 detects the pseudo documents uploaded by the user Y and does not allow user Y to onboard for the one or more solutions associated the facility. In addition, the customer onboarding system 110 detects photo-shop and tampered documents, Xerox or photocopied documents, ID type check, image blur documents, compression quality checks, face match and the like. In addition, the customer onboarding system 110 also performs domain verification, email verification and the like.

In an embodiment of the present disclosure, the customer onboarding system 110 provides access to the valid customer. In addition, the customer onboarding system 110 provides access to the valid customer based on one or more authentication factors. In an example, the one or more authentication factors include biometrics, face recognition, voice recognition, lip synchronization, text password and the like. In addition, the customer onboarding system 110 provides access to the valid customer in real-time. In an example, a user ABC is associated with the customer onboarding system 110. The customer onboarding system 110 provides access to the user ABC to operate the customer onboarding system 110 based on the one or more authentication factor.

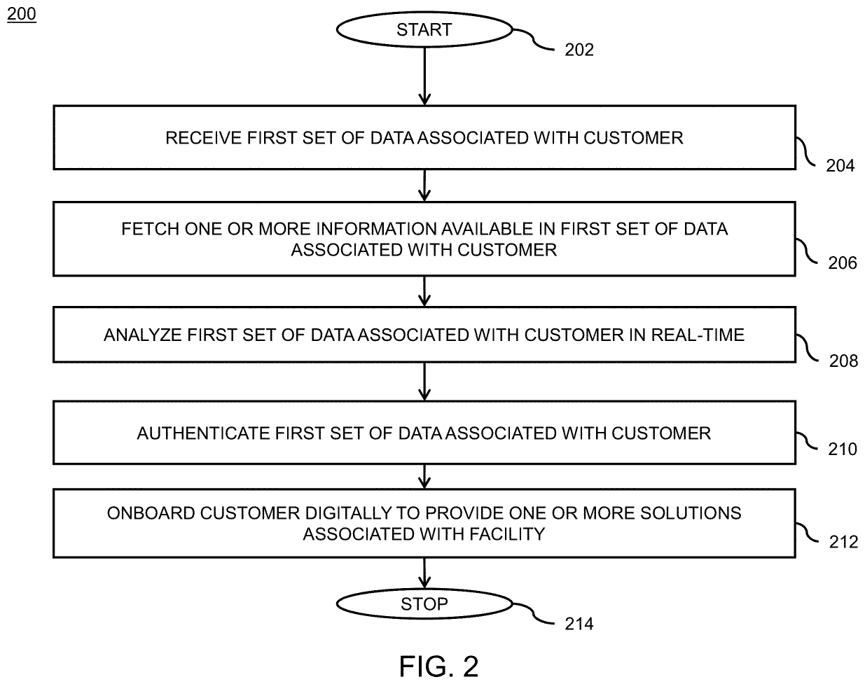

FIG. 2 illustrates a flow chart 200 of a method for onboarding the customer 102 digitally for providing them one or more solutions in real-time, in accordance with various embodiments of the present disclosure. It may be noted that in order to explain the method steps of the flowchart 200, references will be made to the elements explained in FIG. 1.

The flow chart 200 initiates at step 202. Following step 202, at step 204, the customer onboarding system 110 receives the first set of data associated with the customer 102. At step 206, the customer onboarding system 110 fetches one or more information available in the first set of data associated with the customer 102. At step 208, the customer onboarding system 110 analyzes the first set of data associated with the customer 102 in real-time. At step 210, the customer onboarding system 110 authenticates the first set of data associated with the customer 102. At step 212, the customer onboarding system 110 onboard the customer 102 digitally to provide the one or more solutions associated with the facility.

The flow chart 200 terminates at step 214. It may be noted that the flowchart 200 is explained to have above stated process steps; however, those skilled in the art would appreciate that the flowchart 200 may have more/less number of process steps which may enable all the above stated embodiments of the present disclosure.

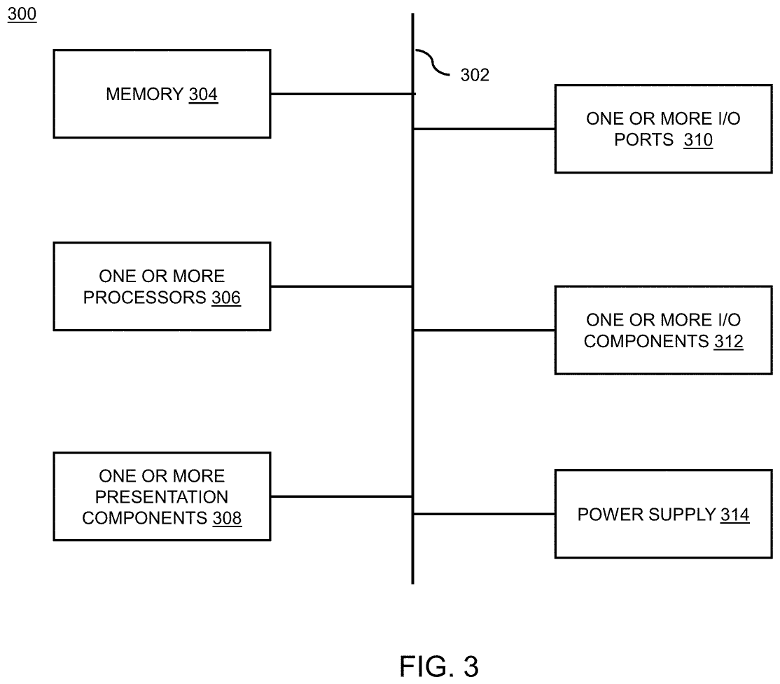

FIG. 3 illustrates a block diagram of a computing device 300, in accordance with various embodiments of the present disclosure. The computing device 300 includes a bus 302 that directly or indirectly couples the following devices: memory 304, one or more processors 306, one or more presentation components 308, one or more input/output (I/O) ports 310, one or more input/output components 312, and an illustrative power supply 314. The bus 302 represents what may be one or more busses (such as an address bus, data bus, or combination thereof). Although the various blocks of FIG. 3 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art and reiterate that the diagram of FIG. 3 is merely illustrative of an exemplary computing device 300 that can be used in connection with one or more embodiments of the present invention. Distinction is not made between such categories as “workstation,” “server,” “laptop,” “hand-held device,” etc., as all are contemplated within the scope of FIG. 3 and reference to “computing device.

The computing device 300 typically includes a variety of computer-readable media. The computer-readable media can be any available media that can be accessed by the computing device 300 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data. The computer storage media includes, but is not limited to, non-transitory computer-readable storage medium that stores program code and/or data for short periods of time such as register memory, processor cache and random access memory (RAM), or any other medium which can be used to store the desired information and which can be accessed by the computing device 300. The computer storage media includes, but is not limited to, non-transitory computer readable storage medium that stores program code and/or data for longer periods of time, such as secondary or persistent long term storage, like read only memory (ROM), EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 300. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 304 includes computer-storage media in the form of volatile and/or nonvolatile memory. The memory 304 may be removable, non-removable, or a combination thereof. Exemplary hardware devices include solid-state memory, hard drives, optical-disc drives, etc. The computing device 300 includes the one or more processors 306 that read data from various entities such as memory 304 or I/O components 312. The one or more presentation components 308 present data indications to a user or other device. Exemplary presentation components include a display device, speaker, printing component, vibrating component, etc. The one or more I/O ports 310 allow the computing device 300 to be logically coupled to other devices including the one or more I/O components 312, some of which may be built in. Illustrative components include a microphone, joystick, game pad, satellite dish, scanner, printer, wireless device, etc.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed:

1. A computer-implemented method for onboarding a customer digitally for providing one or more solutions in real-time, the method comprising:
receiving, at a customer onboarding system with a processor, a first set of data associated with the customer, wherein the first set of data associated with the customer is received in one or more input formats in real-time, wherein the first set of data associated with the customer is received using one or more input hardware devices associated with a communication device, wherein the customer onboarding system receives the first set of data associated with the customer for initiating a process of digitally onboarding of the customer;
fetching, at the customer onboarding system with the processor, one or more information available in the first set of data associated with the customer, wherein the customer onboarding system fetches the one or more information available in the first set of data associated with the customer automatically in real-time;
analyzing, at the customer onboarding system with the processor, the first set of data associated with the customer in real-time, wherein the first set of data associated with the customer is analyzed based on one or more parameters, wherein the customer onboarding system analyzes and auto fills the first set of data associated with the customer using one or more algorithms;
authenticating, at the customer onboarding system with the processor, the first set of data associated with the customer, wherein the customer onboarding system authenticates the first set of data associated with the customer based on combination of one or more pre-defined set of rules associated with a decision engine, wherein the decision engine makes a decision based on combination of the one or more pre-defined set of rules associated with the decision engine, wherein different combination of the one or more pre-defined set of rules is determined on real-time dynamic basis for different customers; and
onboarding, at the customer onboarding system with the processor, the customer, wherein the customer onboarding system on-boards the customer digitally for providing the one or more solutions associated with the facility, wherein the customer onboarding system on-boards the customer based on the decision made by the decision engine in real-time.

2. The computer-implemented method as recited in claim 1, wherein the first set of data associated with the customer comprises one or more government identity proofs of the customer, one or more address verification proofs of the customer and valid GST certificate of a business that the customer owns, wherein the one or more government identity proofs of the customer comprises passport of the customer, birth certificate of the customer, driving license of the customer, social security card of the customer, society welfare card of the customer, income tax card of the customer, ration card of the customer, domicile card of the customer and voter ID card of the customer, wherein the address verification proof of the customer comprises electricity bill of the customer, water consumption bill of the customer, gas consumption bill of the customer, rent agreement of the customer and telephone bill of the customer.

3. The computer-implemented method as recited in claim 1, wherein the one or more input formats comprises one or more multimedia formats of the first set of data associated with the customer, wherein the one or more multimedia formats of the first set of data associated with the customer, wherein the one or more multimedia formats comprises image, video, audio, text and animation.

4. The computer-implemented method as recited in claim 1, wherein the one or more input hardware devices comprises one or more optical devices, microphone, and one or more sensors, wherein the one or more optical devices comprises a smartphone camera, a film camera, a bridge camera, a night vision camera, a thermal imaging camera, an infrared camera and a mirror less camera, wherein the one or more sensors comprises accelerometer, gyroscope, barometer and proximity sensor, wherein the one or more input hardware devices are associated with the communication device.

5. The computer-implemented method as recited in claim 1, wherein the one or more information available in the first set of data associated with the customer comprises name of the customer, date of birth of the customer, address of the customer, gender of the customer, guardian's name of the customer and a unique identity number of the customer.

6. The computer-implemented method as recited in claim 1, wherein the one or more parameters comprises one or more metadata checks, one or more image quality checks, face extraction check, identity type check, one or more identity validity checks, text readability check, wherein the one or more metadata checks comprises modification date check, photo shop check and data modification check, wherein the one or more image quality checks comprises sharpness check, brightness check and text quality check, wherein the one or more identity validity checks comprises digital photo shop check, digital tampering check and Xerox copy check.

7. The computer-implemented method as recited in claim 1, wherein the analyzing is done based on the one or more algorithms, wherein the one or more algorithms comprises one or more machine learning algorithms, wherein the one or more machine learning algorithms comprises one or more subsets, wherein the one or more subsets comprises one or more deep learning models and one or more neural network models.

8. The computer-implemented method as recited in claim 1, further comprising, authorizing, at the customer onboarding system with the processor, modification of the one or more pre-defined set of rules, wherein the customer onboarding system authorizes the facility for modifying the one or more pre-defined set of rules based on alteration of policies fabricated by the administrator, wherein the modification of the one or more pre-defined set of rules is performed in real-time.

9. The computer-implemented method as recited in claim 1, further comprising, detecting, at the customer onboarding system with the processor, pseudo documents uploaded by the customer, wherein the customer onboarding system detects the pseudo documents uploaded by the customer in real-time, wherein the customer onboarding system does not onboard the customer based on the pseudo documents uploaded by the customer.

10. The computer-implemented method as recited in claim 1, further comprising, providing, at the customer onboarding system with the processor, access to a valid customer, wherein the customer onboarding system provides access to the valid customer for operating the customer onboarding system based on one or more authentication factors, wherein the one or more authentication factors comprises biometric authentication, face recognition, voice recognition, lip synchronization, and text authentication.

11. A computer system comprising:
one or more processors; and
a memory coupled to the one or more processors, the memory for storing instructions which, when executed by the one or more processors, cause the one or more processors to perform a method for providing one or more solutions in real-time, the method comprising:
receiving, at a customer onboarding system, a first set of data associated with the customer, wherein the first set of data associated with the customer is received in one or more input formats in real-time, wherein the first set of data associated with the customer is received using one or more input hardware devices associated with a communication device, wherein the customer onboarding system receives the first set of data associated with the customer for initiating a process of digitally onboarding of the customer;
fetching, at the customer onboarding system, one or more information available in the first set of data associated with the customer, wherein the customer onboarding system fetches the one or more information available in the first set of data associated with the customer automatically in real-time;
analyzing, at the customer onboarding system, the first set of data associated with the customer in real-time, wherein the first set of data associated with the customer is analyzed based on one or more parameters, wherein the customer onboarding system analyzes and auto fills the first set of data associated with the customer using one or more algorithms;
authenticating, at the customer onboarding system, the first set of data associated with the customer, wherein the customer onboarding system authenticates the first set of data associated with the customer based on combination of one or more pre-defined set of rules associated with a decision engine, wherein the decision engine makes a decision based on combination of the one or more pre-defined set of rules associated with the decision engine, wherein different combination of the one or more pre-defined set of rules is determined on real-time dynamic basis for different customers; and
onboarding, at the customer onboarding system, the customer, wherein the customer onboarding system on-boards the customer digitally for providing the one or more solutions associated with the facility, wherein the customer onboarding system on-boards the customer based on the decision made by the decision engine in real-time.

12. The computer system as recited in claim 11, wherein the first set of data associated with the customer comprises one or more government identity proofs of the customer, one or more address verification proofs of the customer and valid GST certificate of a business that the customer owns, wherein the one or more government identity proofs of the customer comprises passport of the customer, birth certificate of the customer, driving license of the customer, social security card of the customer, society welfare card of the customer, income tax card of the customer, ration card of the customer, domicile card of the customer and voter ID card of the customer, wherein the address verification proof of the customer comprises electricity bill of the customer, water consumption bill of the customer, gas consumption bill of the customer, rent agreement of the customer and telephone bill of the customer.

13. The computer system as recited in claim 11, wherein the one or more input formats comprises one or more multimedia formats of the first set of data associated with the customer, wherein the one or more multimedia formats of the first set of data associated with the customer, wherein the one or more multimedia formats comprises image, video, audio, text and animation.

14. The computer system as recited in claim 11, wherein the one or more information available in the first set of data associated with the customer comprises name of the customer, date of birth of the customer, address of the customer, gender of the customer, guardian's name of the customer and a unique identity number of the customer.

15. The computer system as recited in claim 11, wherein the one or more parameters comprises one or more metadata checks, one or more image quality checks, face extraction check, identity type check, one or more identity validity checks, text readability check, wherein the one or more metadata checks comprises modification date check, photo shop check and data modification check, wherein the one or more image quality checks comprises sharpness check, brightness check and text quality check, wherein the one or more identity validity checks comprises digital photo shop check, digital tampering check and Xerox copy check.

16. The computer system as recited in claim 11, wherein the analyzing is done based on the one or more algorithms, wherein the one or more algorithms comprises one or more machine learning algorithms, wherein the one or more machine learning algorithms comprises one or more subsets, wherein the one or more subsets comprises one or more deep learning models and one or more neural network models.

17. The computer system as recited in claim 11, further comprising, authorizing, at the customer onboarding system, modification of the one or more pre-defined set of rules, wherein the customer onboarding system authorizes the facility for modifying the one or more pre-defined set of rules based on alteration of policies fabricated by the administrator, wherein the modification of the one or more pre-defined set of rules is performed in real-time.

18. The computer system as recited in claim 11, further comprising, detecting, at the customer onboarding system, pseudo documents uploaded by the customer, wherein the customer onboarding system detects the pseudo documents uploaded by the customer in real-time, wherein the customer onboarding system does not onboard the customer based on the pseudo documents uploaded by the customer.

19. The computer system as recited in claim 11, further comprising, providing, at the customer onboarding system, access to a valid customer, wherein the customer onboarding system provides access to the valid customer for operating the customer onboarding system based on one or more authentication factors, wherein the one or more authentication factors comprises biometric authentication, face recognition, voice recognition, lip synchronization, and text authentication.

20. A non-transitory computer-readable storage medium encoding computer executable instructions that, when executed by at least one processor, performs a method for providing one or more solutions in real-time, the method comprising:
receiving, at a computing device, a first set of data associated with the customer, wherein the first set of data associated with the customer is received in one or more input formats in real-time, wherein the first set of data associated with the customer is received using one or more input hardware devices associated with a communication device, wherein a customer onboarding system receives the first set of data associated with the customer for initiating a process of digitally onboarding of the customer;
fetching, at the computing device, one or more information available in the first set of data associated with the customer, wherein the customer onboarding system fetches the one or more information available in the first set of data associated with the customer automatically in real-time;
analyzing, at the computing device, the first set of data associated with the customer in real-time, wherein the first set of data associated with the customer is analyzed based on one or more parameters, wherein the customer onboarding system analyzes and auto fills the first set of data associated with the customer using one or more algorithms;
authenticating, at the computing device, the first set of data associated with the customer, wherein the customer onboarding system authenticates the first set of data associated with the customer based on combination of one or more pre-defined set of rules associated with a decision engine, wherein the decision engine makes a decision based on combination of the one or more pre-defined set of rules associated with the decision engine, wherein different combination of the one or more pre-defined set of rules is determined on real-time dynamic basis for different customers; and
onboarding, at the computing device, the customer, wherein the customer onboarding system on-boards the customer digitally for providing the one or more solutions associated with the facility, wherein the customer onboarding system on-boards the customer based on the decision made by the decision engine in real-time.
